(19) United States
(12) Patent Application Publication
(10) Pub. No.: US 2005/0112035 A1
(43) Pub. Date: May 26, 2005

(54) Method and apparatus for generating oxygen

(76) Inventor: Julian Ross, McKinney, TX (US)

Correspondence Address: CARR LAW FIRM, L.L.P., 670 FOUNDERS SQUARE, 900 JACKSON STREET, DALLAS, TX, 75202, US

(21) Appl. No.: 10/718,131

(22) Filed: Nov. 20, 2003

(51) Int. Cl. A62B 7/08

(52) U.S. Cl. 422/120

(57) ABSTRACT

A method and apparatus are provided for generating Oxygen. Water-soluble chemicals are mixed in water, and the result is medically pure Oxygen. The water-soluble chemicals have long shelf-lives and are non-toxic, not an environmental hazard, not a fire hazard, and not an explosive hazard. Once the reaction is complete, the remaining waste solution can be disposed of in a conventional waste disposal system with no adverse affects. All of these attributes contribute to a safe, compact, and easily usable Oxygen generation system.

### BACKGROUND OF THE INVENTION

1. Field of the Invention

The invention relates generally to oxygen generation and, more particularly, to robust oxygen generation from a solid or liquid.

2. Description of the Related Art

Highly pure oxygen gas is used within a variety of applications. More particularly, medical devices use highly pure oxygen for patient care. However, production or generation, transportation, delivering, usage and storage of oxygen can be both cumbersome and dangerous.

Typical devices today utilize a variety of means to store and produce oxygen. Far and above, the most common apparatus is a compressed gas tank. The compressed gas tank, though, is heavy, requires a regulator, and can be quite dangerous. Oxygen is a very reactive element that can be explosive. Therefore, compressed tanks of pure Oxygen gas can pose a very realistic fire or explosive hazard.

There are a variety of other Oxygen generation devices that utilize chemical reactions. For example, Oxygen generation canisters are used in passenger aircraft for supplying Oxygen to passengers if the aircraft depressurizes. These canisters, though, can be very unstable devices, especially once the canisters have been deemed to have outlived their respective shelf-lives. In addition, these canisters typically require a spark to initiate the chemical reaction.

Moreover, with both compressed gas and chemical generators, each type typically requires metal containers and safety equipment. These metal containers are highly subjected to corrosion, which could render the container useless. These metal containers may also require ongoing maintenance, and have moving parts. Also, utilization of metal containers can be quite heavy. As a consequence, they can limit the range of applications for usage, or they may not be well-suited to a broad range of applications.

Therefore, there is a need for a method and/or apparatus for generating Oxygen that is more robust and less hazardous and that addresses at least some of the problems associated with conventional methods and apparatuses for producing or generating, transporting, using, delivering or storing Oxygen.

### SUMMARY OF THE INVENTION

The present invention provides an apparatus for generating Oxygen. The apparatus comprises a vessel. Also, the apparatus comprises an aqueous, Oxygen producing solution contained in the vessel, wherein the resulting waste solution is at least configured to be non-toxic and wherein the resulting waste solution is at least configured to not be an environmental hazard.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting an Oxygen generator;

FIG. 2 is a flow chart depicting a first method of producing Oxygen;

FIG. 3 is a flow chart depicting a second method of producing Oxygen; and

FIG. 4 is a flow chart depicting a third method of producing Oxygen.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning mechanical connections, simple inorganic chemistry, and the like, have been omitted inasmuch as such details are not considered necessary to obtain a complete understanding of the present invention, and are considered to be within the understanding of persons of ordinary skill in the relevant art.

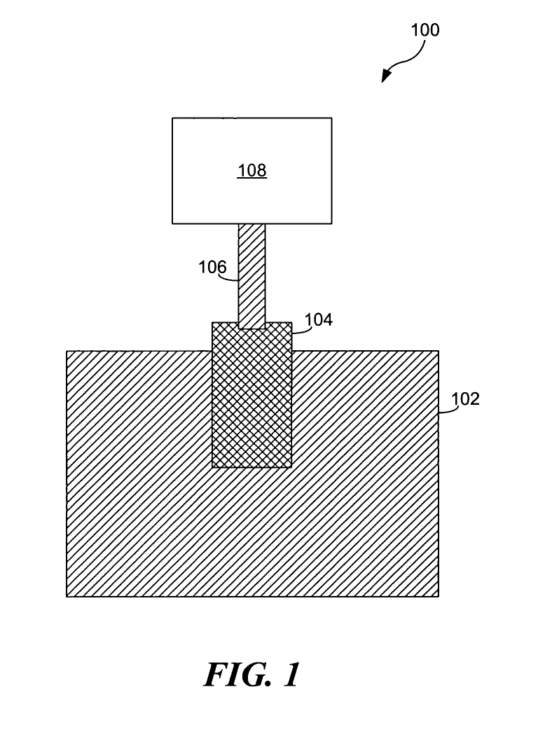

Referring to FIG. 1 of the drawings, the reference numeral 100 generally designates an Oxygen generator. The Oxygen generator comprises a vessel 102, a humidifier 104, output line 106, and a usage device 108.

The vessel 102 contains the compartment where a chemical reaction that produces the Oxygen takes place. The vessel 102 can be composed of a variety of materials. For example, the vessel can be composed of polypropylene. However, the Oxygen generator 100 only requires that the vessel 102 be composed of a material that can withstand, or which has a conductivity to withstand, the heat generated inside the vessel 102 during the chemical reaction. Typically, the walls of the vessel can vary in thickness. However, the Oxygen generator 100 only requires that the walls of the vessel 102 have a thickness that can withstand the internal pressures that result from aqueous solutions and gas pressure.

The oxygen generated within the vessel 102 is a result of a chemical reaction. The chemical reaction takes place in an aqueous environment so, that upon complete depletion of a limiting reactant, the remaining waste solution can be discarded into conventional waste disposal systems. The waste solution is also not an environmental hazard as defined by generally accepted systems for measuring material properties, such as the Environmental Protection Agency's (EPA) Risk Screening Environmental Indicators Model. For example, the waste solution can be soda ash dissolved in water.

In order to achieve the desired Oxygen generation and environmental acceptability, there are several chemicals that can be utilized. The limiting reactant should be a water-soluble powder or liquid that is non-toxic, not an environmental hazard, not an explosive, not a fire hazard, and have a long shelf-life. Non-toxic, not a fire hazard, and not an explosive can be defined as compounds that are not deemed to be, respectively, non-toxic, a fire hazard, or an explosive, by a generally accepted system for measuring material properties, such as the Hazardous Materials Information System (HMIS). Also, a long shelf-life can be defined as a material that can be stored for an indefinite period of time when stored below the standard temperature of 86° Fahrenheit (F.). For example, Sodium Percarbonate (2Na₂CO₃.3H₂O₂) powder can be an acceptable material that can be dissolved in water. The resulting waste liquid from using Sodium Percarbonate (2Na₂CO₃.3H₂O₂) in an Oxygen generation reaction is an aqueous solution of Soda Ash. There are also a variety of other chemicals that can be used as the limiting reactant, such as Sodium Perborate (NaBHO₃).

These powders or liquids, though, can also require the use of a catalyst. The catalysts, too, should be water-soluble, non-toxic, not an environmental hazard, not an explosive, not a fire hazard, and have a long shelf-life. Typically, a metal-based catalyst can be used to initiate the chemical reaction, combined with a hydrated salt to absorb the heat generated during the reaction. For example, a combination of a Manganese compound and a Sodium-based compound or similar hydrated salt can be used. There are also a variety of catalysts that can be used, such as compounds containing Iron or Iron Oxides and Copper or Copper Oxides.

Intuitively, the flow rate from the generators can be varied. Depending on the amount of the limiting reactant and the amount of the catalyst, the flow rate varies. Generation of Oxygen could occur continuously or for predetermined periods of time depending on the amount of the limiting reactant and the catalyst.

Once a limiting reactant and, possibly, a catalyst have been added to water contained within the vessel 102, then a humidifier 104 allows for the humidification and/or cooling of Oxygen generated within the vessel 102. Typically, the humidifier 104 humidifies, or adds water vapor, to the volume of Oxygen gas being generated. The various configurations of the humidifier can also vary the amount of humidity that can be added to the flow of Oxygen. For example, the humidifier 104 can be configured for use by an individual where the relative humidity of the Oxygen gas is 65%. The humidifier can have a variety of configurations that can also vary the temperature of the Oxygen out of the vessel 102.

Attached to the humidifier 104 is a carrying tube 106. The carrying tube carries to a usage device 108. The tube may be a variety of configurations. For example, the carrying tube can be standard medical tubing. Also, the carrying tube can be omitted in order to provide Oxygen to a room or compartment. The usage device can also be a variety of configurations. For example, the usage device can be a standard medical breathing mask.

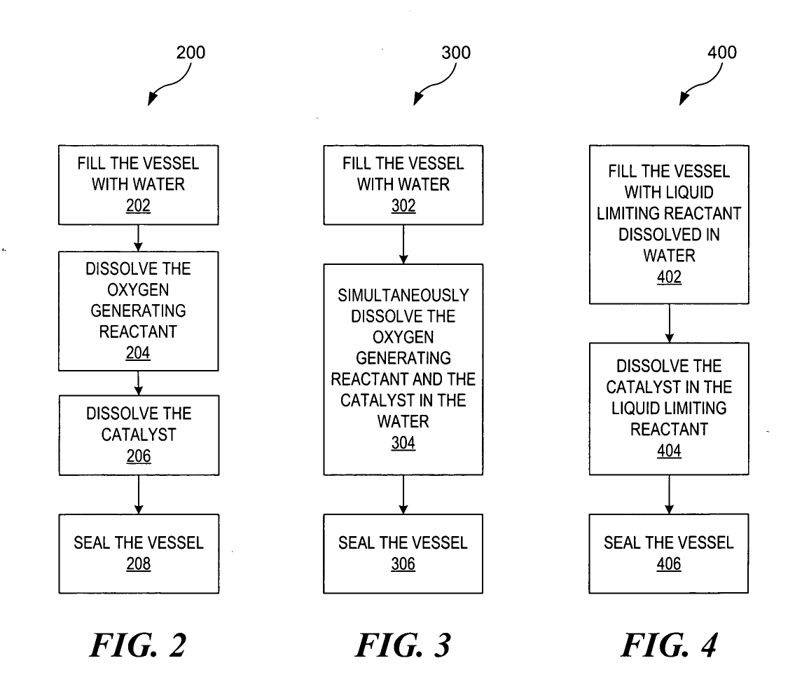

Referring to FIG. 2 of the drawings, the reference numeral 200 generally designates a flow chart depicting a first method of producing oxygen.

Steps 202, 204, 206, and 208 provide a first method for generating Oxygen that utilizes the Oxygen generator of FIG. 1. In step 202, water is added to the vessel 102 of FIG. 1. In step 204, the limiting reactant powder is added to the water and dissolved. In step 206, the catalyst, if any, is added to the aqueous solution containing the limiting reactant. In step 208, the vessel 102 of FIG. 1 is sealed. The Oxygen generated from the Oxygen generator of FIG. 1 can then be used for a variety of purposes.

Referring to FIG. 3 of the drawings, the reference numeral 300 generally designates a flow chart depicting a second method of producing oxygen.

Steps 302, 304, and 306 provide a second method for generating Oxygen that utilizes the Oxygen generator of FIG. 1. In step 302, water is added to the vessel 102 of FIG. 1. In step 304, the limiting reactant powder and the catalyst, if any, are simultaneously added to the water. In step 306, the vessel 102 of FIG. 1 is sealed. The Oxygen generated from the Oxygen generator of FIG. 1 can then be used for a variety of purposes.

Referring to FIG. 4 of the drawings, the reference numeral 400 generally designates a flow chart depicting a third method of producing oxygen.

Steps 402, 404, and 406 provide a third method for generating Oxygen that utilizes the Oxygen generator of FIG. 1. In step 402, a liquid limiting reactant dissolved in water is added to the vessel 102 of FIG. 1. In step 404, the catalyst, if any, is added to the liquid limiting reactant. In step 406, the vessel 102 of FIG. 1 is sealed. The Oxygen generated from the Oxygen generator of FIG. 1 can then be used for a variety of purposes.

It will further be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. An apparatus for generating Oxygen, comprising:
a vessel; and
an aqueous, Oxygen producing solution contained in the vessel, wherein a resulting waste solution is at least non-toxic and wherein the resulting waste solution is at least not an environmental hazard.

2. The apparatus of claim 1, wherein the aqueous, Oxygen producing solution further comprises a reactant selected from the group consisting of Sodium Percarbonate (2Na₂CO₃.3H₂O₂) or Sodium Perborate (NaBHO₃) dissolved in water.

3. The apparatus of claim 1 or 2, wherein the aqueous, Oxygen producing solution further comprises a water-soluble catalyst, wherein the water-soluble catalyst is at least non-toxic, at least not an environmental hazard, at least not an explosive hazard, at least not a fire hazard, and at least having a long shelf-life.

4. The apparatus of claims 1, wherein the aqueous, Oxygen producing solution further comprises a catalyst of Manganese Dioxide (MnO₂) and Sodium Carbonate (Na₂CO₃).

5. The apparatus of claims 3, wherein the water-soluble catalyst further comprises a mixture of Manganese Dioxide (MnO₂) and Sodium Carbonate (Na₂CO₃)

6. The apparatus of claims 1, wherein the aqueous, Oxygen producing solution further comprises a catalyst of metal oxide.

7. The apparatus of claims 3, wherein the water-soluble catalyst further comprises a metal oxide.

8. The apparatus of claim 1, wherein the apparatus further comprises a humidifier at least configured to be coupled to the vessel.

9. The apparatus of claim 8, wherein the apparatus further comprises a carrier tube at least configured to be attached the humidifier.

10. An apparatus for generating Oxygen, comprising:
a vessel to at least contain an aqueous reaction; and
a water-soluble reactant to at least be used as an Oxygen producing reactant in the aqueous reaction, wherein the water-soluble reactant is at least be non-toxic, at least not an environmental hazard, at least not an explosive hazard, at least not a fire hazard, and at least having long shelf-life.

11. The apparatus of claim 10, wherein the water-soluble reactant further comprises a reactant selected from the group consisting of Sodium Percarbonate (2Na₂CO₃.3H₂O₂) or Sodium Perborate (NaBHO₃) dissolved in water.

12. The apparatus of claim 10 or 11, wherein apparatus further comprises a water-soluble catalyst, wherein the water-soluble catalyst is at least non-toxic, at least not an environmental hazard, at least not an explosive hazard, at least not a fire hazard, and at least having long shelf-life.

13. The apparatus of claims 10, wherein apparatus further comprises a catalyst of Manganese Dioxide (MnO₂) and Sodium Carbonate (Na₂CO₃).

14. The apparatus of claims 12, wherein the water-soluble catalyst further comprises a mixture of Manganese Dioxide (MnO₂) and Sodium Carbonate (Na₂CO₃).

15. The apparatus of claims 10, wherein apparatus further comprises a catalyst of metal oxide.

16. The apparatus of claims 12, wherein the water-soluble catalyst further comprises a metal oxide.

17. The apparatus of claim 10, wherein the apparatus further comprises a humidifier at least configured to be coupled to the vessel.

18. The apparatus of claim 17, wherein the apparatus further comprises a carrier tube at least configured to be attached the humidifier.

19. An apparatus for generating Oxygen, comprising:
a vessel to at least contain an aqueous reaction;
a water-soluble powder or liquid at least to be used as a reactant in the aqueous reaction, wherein the water-soluble powder is at least non-toxic, at least not an environmental hazard, at least not an explosive hazard, at least not a fire hazard, and at least having a long shelf-life; and
a water-soluble catalyst, wherein the water-soluble powder is at least non-toxic, at least not an environmental hazard, at least not an explosive hazard, at least not a fire hazard, and at least having a long shelf-life.

20. The apparatus of claim 19, wherein the water-soluble powder or liquid further comprises a reactant selected from the group consisting of Sodium Percarbonate (2Na₂CO₃.3H₂O₂) or Sodium Perborate (NaBHO₃) dissolved in water.

21. The apparatus of claim 19 or 20, wherein the water-soluble powder or liquid further comprises a water-soluble catalyst, wherein the water-soluble catalyst is at least non-toxic, at least not an environmental hazard, at least not an explosive hazard, at least not a fire hazard, and at least having a long shelf-life.

22. The apparatus of claims 19, wherein the water-soluble catalyst further comprises a catalyst of Manganese Dioxide (MnO₂) and Sodium Carbonate (Na₂CO₃).

23. The apparatus of claims 21, wherein the water-soluble catalyst further comprises a mixture of Manganese Dioxide (MnO₂) and Sodium Carbonate (Na₂CO₃).

24. The apparatus of claims 19, wherein water-soluble catalyst further comprises a catalyst of metal oxide.

25. The apparatus of claims 21, wherein the water-soluble catalyst further comprises a metal oxide.

26. The apparatus of claim 19, wherein the apparatus further comprises a humidifier at least configured to be coupled to the vessel.

27. The apparatus of claim 26, wherein the apparatus further comprises a carrier tube at least configured to be attached the humidifier.

28. A method for operating an Oxygen producing generator, comprising:
filling a vessel with water;
dissolving a water-soluble powder or liquid at least used as a Oxygen producing reactant, wherein the water-soluble powder is at least non-toxic, at least not an environmental hazard, at least not an explosive hazard, at least not a fire hazard, and at least having a long shelf-life.

29. The method of claim 28, wherein a the method further comprises:
dissolving a water-soluble catalyst after the water-soluble powder is dissolved, wherein the water-soluble powder is at least non-toxic, at least not an environmental hazard, at least not an explosive hazard, at least not a fire hazard, and at least having a long shelf-life.

30. The method of claim 28, wherein a the method further comprises:
dissolving a water-soluble catalyst simultaneously with the water-soluble powder, wherein the water-soluble powder is at least non-toxic, at least not an environmental hazard, at least configured not an explosive hazard, at least not a fire hazard, and at least having long shelf-life.
